(19) United States
(12) Patent Application Publication
(10) Pub. No.: US 2009/0185454 A1
(43) Pub. Date: Jul. 23, 2009

(54) Fillable hourglass and method of using fillable hourglass

(75) Inventors: Jeffrey J. Allen, Newport, NY (US); Stephanie A. Allen, Newport, NY (US)

Correspondence Address: BOND, SCHOENECK & KING, PLLC, ONE LINCOLN CENTER, SYRACUSE, NY, 13202-1355, US

(73) Assignee: Heirloom Hourglass, LLC, Newport, NY (US)

(21) Appl. No.: 12/183,402

(22) Filed: Jul. 31, 2008

Related U.S. Application Data
(60) Provisional application No. 61/011,766, filed on Jan. 22, 2008.
(60) Provisional application No. 61/066,265, filed on Feb. 19, 2008.

(51) Int. Cl. G04F 1/04; B65B 1/04

(52) U.S. Cl. 368/93; 141/1

(57) ABSTRACT

A fillable hourglass having a glass component with opening permitting access to the inside of the glass component, a base with a least one opening in communication with the opening of the glass component, and a stopper for selectively opening and closing access to the glass component. The base is preferably formed from two planar members supported in spaced relation by decorative pillars. The stoppers may include decorative enhancements, such as being shaped in the design of a nautical steering wheel. The hourglass may be used as part of wedding sand ceremonies or to hold particular matter related to the wedding ceremony, or as an urn for storing crematory remains of a human or animal.

### CROSS-REFERENCE TO RELATED APPLICATIONS

This application claims priority to U.S. Provisional Patent Application Ser. No. 60/964,204, filed Aug. 10, 2007, U.S. Provisional Patent Application Ser. No. 61/011,766, filed Jan. 22, 2008, and U.S. Provisional Patent Application Ser. No. 61/066,265, filed Feb. ______, 2008.

### BACKGROUND OF THE INVENTION

1. Field of the Invention

The present invention relates to time measuring systems and, more particular, to a gravity based interval timer that may be selectively opened and closed.

2. Description of the Related Art

Hourglasses of many varieties have been in use since ancient times, and are widely associated with nautical, professional, culinary, and decorative applications. Generally, an hourglass consists of two hollow glass compartments varying in shape and size that are connected by a narrow glass passageway. The hourglass is generally made from glass, and is typically housed between two bases connected by two, three, or four columns or pillars. These bases and columns vary widely in design, style, size, materials, finishes, and embellishments used.

The glass component of the typical hourglass is filled with sand or some granular, particulate matter and sealed. Factors such as the size and weight of the granules and the dimension of the narrow passageway connecting the two hollow glass compartments determine the rate at which the granules flow via gravity from one compartment to the other. When all the sand or similar material stored within the hourglass is in the lower compartment, the hourglass is inverted and the period of time to be measured begins. When all the material has flowed through from the upper compartment to the lower, the time being measured is complete. This method of measuring time is very well known and has been in use for hundreds of years.

For use in modern times, the hourglass primarily has a tremendous decorative visual appeal and many desirable qualities and aesthetics, but it is no longer a preferred and widely used method for marking the passage of time. In addition, the glass components of hourglasses are sealed when constructed, thereby preventing the user from easily accessing or changing the contents. Because of this, there is a long felt need for an hourglass that can be opened and closed, and filled and refilled by the user with any type of material they wish at any time.

Wedding unity ceremonies have been in use as part of weddings for many years. People from all over the world incorporate unity ceremonies into their weddings because these ceremonies have symbolic and meaningful attributes that enhance the wedding experience and make it unique. In the unity candle ceremony, for instance, the bride and groom each receive a lit candle from their parents and use them to simultaneously light their unity candle. An officiant reads a corresponding ceremony of the couple's choice during this time, and the lighting of the unity candle is viewed as symbolic of the union of marriage. There are many variations of this example, and the end result is a touching addition to the wedding and the candle itself becomes a keepsake for the couple that is considered symbolic of their wedding day.

A second example of an existing wedding unity ceremony is the sand ceremony, which has gained great attention and popularity in recent years. In a sand ceremony, the bride and groom are instructed by the officiant to each pour sand into a vase either one at a time or simultaneously. The sands are considered to be symbolic of the couple and their union of marriage, just as the lighting of the candle in the aforementioned example.

There has been a long felt need for an alternative to the unity candle ceremony for a variety of reasons. One of these reasons is that many churches and other religious sites restrict the use of candles in weddings because of the fear of fire damage to the property. Another reason is the fact that many weddings are held outside and on beaches, and the use of candles is difficult, if not impossible, because of the wind or weather, and the difficulty in predicting them.

There has also been a long felt need for improvements to the traditional sand unity Ceremony. The primary reason for this is that an appropriate keepsake or heirloom vessel into which the sand is filled has been lacking. In addition, the sand just rests in a vase, and the vase does not provide for the sand to readily flow or blend together. Additionally, most vases used lack the utility of an attractive, easy to use mechanism for the opening and sealing of the vase. The sands from the ceremony are therefore not ideally stored for the purposes of display and for the purposes of passing them down through generations of the family as a keepsake or heirloom.

There has also been a long felt need for an alternative to traditional wedding unity ceremonies, such as the unity candle ceremony and the unity sand ceremony. The feeling for this need arises from the desire to make the wedding day a unique experience, to display a unique symbol of the union of marriage and the joining of the families, to include extended family members when applicable, and in doing these things create an appropriate keepsake or family heirloom. Many couples that desire to have an outdoor wedding or beach wedding have had a long felt need to incorporate appropriate ceremony addition to their wedding. Couples in general have had the long felt need for a wedding ceremony that can result in a tradition that can be used in whole or part for the purposes of their subsequent honeymoon, anniversaries, vacations, gifts, special events, creating of family heirlooms, and/or renewing of vows.

Cremation has become both an acceptable and popular method of laying both deceased humans and pets to rest, and is widely considered a respectful and responsible final act for a relative, pet, or loved one. For instance, it is estimated that eighty percent of the deceased in the state of Colorado are cremated instead of being layed to rest using burial methods. As a result of the increase in acceptance and popularity of cremation, there has been a sharp increase in the demand and need for crematory urns. Used for the storage and/or display of the cremated remains, crematory urns now come in a very wide variety of sizes, styles, and shapes, and many different materials are used to produce them. Many urns are designed to display all of or just a portion of human or pet remains. These are widely referred to as keepsake crematory urns. People may disperse a portion of the ashes at sea or another location, and then keep a percentage of the ashes in a keepsake crematory urn. It is widely felt that this is an appropriate means of honoring the final wishes of the deceased and laying them to rest in a respectful way. It also is considered to be comforting to those survived by the deceased, and to serve as a proper and preferred method of memorial and remembrance. Accordingly, there is a need for a keepsake crematory urn that is easy to fill and display.

### BRIEF SUMMARY OF THE INVENTION

It is therefore a principal object and advantage of the present invention to provide a fillable hourglass.

It is an additional object and advantage of the present invention to provide an hourglass that may be used as part of a wedding ceremony.

It is a further object and advantage of the present invention to provide an hourglass that may be used to display at least a portion of the remains or a pet or loved one.

In accordance with the foregoing objects and advantages, the present invention provides a fillable hourglass that allows a user to open and close the hourglass very easily and using an ornately designed threaded closure on each end. The user may thus fill the hourglass with whatever they wish, and use an hourglass as part of a wedding unity ceremony and/or sand ceremony. The items the user fills the hourglass with may be of personal value to the user and they may feel that they commemorate or symbolize a memorable personal experience, such as a wedding, anniversary, holiday, or many other unique and/or special events, or the people involved. It is widely felt that hourglasses are no longer practical for measuring the passage of time, but they still have highly sought after decorative qualities, and can be used to appropriately store and display items of personal value and visual appeal. The present invention seeks to address this need by providing the user with an hourglass that can be opened and closed from either end with a simple threaded closure. The present invention thus allows a user to fill and refill it for the purposes of decorative storage and display, and for use in wedding unity ceremonies.

The present invention may be used in connection with an hourglass wedding unity sand ceremony, by providing a fillable hourglass designed to be easily opened and closed anytime the user wishes, and primarily for giving the user access to the inside of an hourglass so that they can fill it with sands or other small objects from their wedding day. The present invention improves upon existing wedding unity ceremonies and offers a unique alternative to them by virtue of the use of the fillable hourglass. During an hourglass wedding unity sand ceremony, the bride and groom each fill the hourglass one at a time or simultaneously with sand, small objects, and/or other particulate matter. A collection kit may be provided with the fillable hourglass for the purposes of collecting and screening the sand or other materials. A screen may be included with a fillable hourglass as part of the invention to provide a means by which only materials that will pass through the screen holes can be selected for use in the hourglass, so that users have the option to fill the present invention with screened sand so that the sand will flow through the center hole without clogging.

A kit according to the present invention may include a jute drawstring bag, a plastic sealable bag, a pipe cleaner, a scoop, a funnel, and the aforementioned screening device. The screen is preferably made from a rigid mesh material that is cut to a circular shape of approximately three and one-quarter inches in diameter and glued or fastened to a tape core or similar object. The holes in the mesh material of the screen are sized slightly smaller than the center hole of the glass component of the fillable hourglass to ensure screened materials will fit through the center hole of said fillable hourglass. After using the collection kit included as part of this invention, collected and screened sand may be used as part of the hourglass wedding unity sand ceremony. To perform the ceremony, the fillable hourglass will be filled using sand holders and a funnel. The sand holders used will contain a pre-measured amount of sand or other material, and the sand holders can be glass containers, shells, candle votives, or many other small containers that the participants in the ceremony may wish to utilize. A glass funnel or other type of funnel is used for filling the hourglass. A glass funnel is recommended as part of this invention because it provides the utility of resting in the tillable hourglass without having to be held in place. As the beach sand, colored sand, or other materials are poured into the fillable hourglass by the bride and groom, the officiant reads the appropriate vows. Colored sand may be used to symbolize the bride and groom, and/or their families. The joining of the sands in the hourglass is symbolic of the union of marriage and the joining of the individuals and/or their families.

Beach sand is sometimes used from the location the ceremony is taking place at, or from other locations that the couple consider meaningful or symbolic to them. Small shells, gemstones, pebbles, seaglass, soil, ashes, and many other objects may also be used by virtue of the use of the fillable hourglass. Extended family members or children may also be included in the hourglass wedding unity sand ceremony. A written ceremony suggested for use by the couple and their officiant may be provided with instructions for carrying out the ceremony during the Wedding.

When the ceremony is complete, the fillable hourglass is sealed from either side the threaded closures. As a result of the ceremony, the couple now has an hourglass filled with sand or other material from their wedding day. If the material the hourglass was filled with during the ceremony was screened with the screening device provided in the collection kit, the sands will flow each time the hourglass is turned over. This is symbolic of the couple, their marriage, and their families as the sands from the wedding day blend more and more each time the hourglass is turned over.

The present invention thus provides an heirloom that is well conceived and constructed so that the couple can pass it down through many generations of their family if so desired. To personalize and preserve the memories of the wedding day, a story book may be included with the fillable hourglass in the collection kit. Each book is individually numbered and includes space for the couple to record information about the fillable hourglass and the ceremony. This information they may record includes, but is not limited to dates, locations, names, and a general overview of the proceedings. The couple may also opt to apply engraved metal plates to the fillable hourglass that show similar information and match the colors or aesthetic qualities of the fillable hourglass, or that simply appeal to the user. As an alternative, the closure may comprise a smooth design, such as a pewter heart, that can be engraved.

The present invention may also be used as an hourglass crematory urn designed to be easily opened and closed any time the user wishes, and primarily for giving the user access to the inside of an hourglass so that they can fill it with the cremated remains of a relative, loved one, or pet. The hourglass crematory urn will be used to store and display cremated remains, and serve as a memorial, a method of remembrance, and as a keepsake.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a perspective view of an hourglass according to the present invention.

FIG. 2 is another perspective view of an hourglass according to the present invention

FIG. 3 is a cross-section of an hourglass according to the present invention.

FIG. 4 is a perspective view of a portion of an hourglass according to the present invention.

FIG. 5 is a perspective view of an hourglass kit according to the present invention

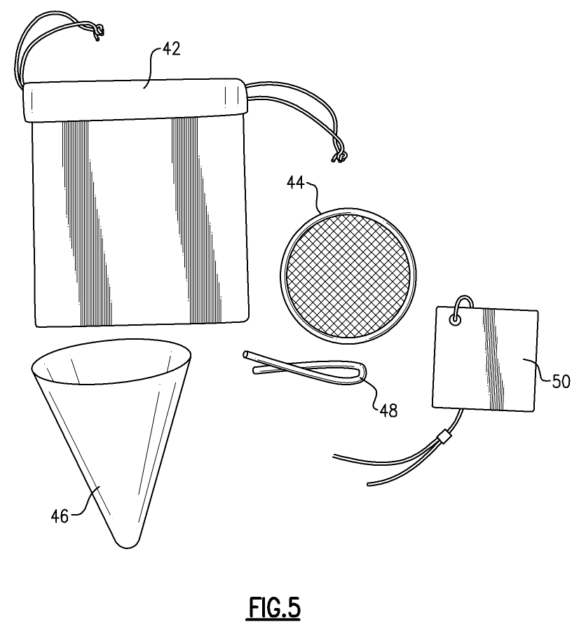

### DETAILED DESCRIPTION OF THE INVENTION

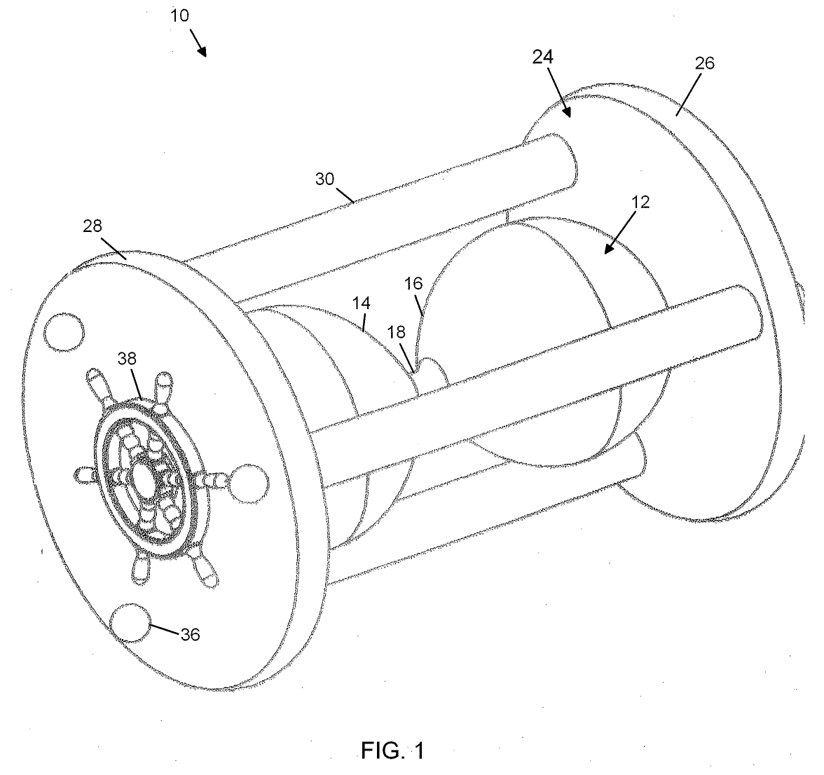

Referring now to the drawings, wherein like reference numerals refer to like parts throughout, there is seen in FIG. 1 a fillable hourglass 10 having a container 12 defining dual chambers 14 and 16 in fluid communication with each other and separated by a neck 18 having a reduced diameter for controlling the movement of particles from one chamber into the other.

Hourglass 10 further comprises at least one opening 20 in container 12 permitting access to chamber 14 or 16. A second opening 22 may be provided at the opposing end of component 10 for permitting access to the other of chamber 14 or 16. Openings 20 and 22 accommodate the opening or closing, and filling or emptying of hourglass 10.

Hourglass 10 is supported in a holder 24 comprising two opposing bases 26 and 28 held in spaced relation by one or more pillars 30. Bases 26 and 28 include apertures 32 and 34 formed therethough and positioned proximately to and in fluid communication with opening 20 and 22. Bases 26 and 28 may be attached to pillars 30 by any convention means, such as threaded inserts pressed in the end of pillars 30, which extend through bases 26 and 28 and are capped by correspondingly threaded knobs 36. In a preferred embodiment, the inserts are one-quarter inch 6-32 brass threaded inserts pressed into pillars 30 and connected to three-quarter inch wooden ball knobs 36. Six pieces of 6-32 type threaded rod may be cut to approximately 1.25 inches in length and passed through the 0.144 inch holes drilled in three places equally spaced on a 4.30 inch diameter circle on bases 26 and 28. Each insert is used to secure knobs 36 to pillars 30 and may include with a thread locker, such as loctite, for strength and creating a secure bond.

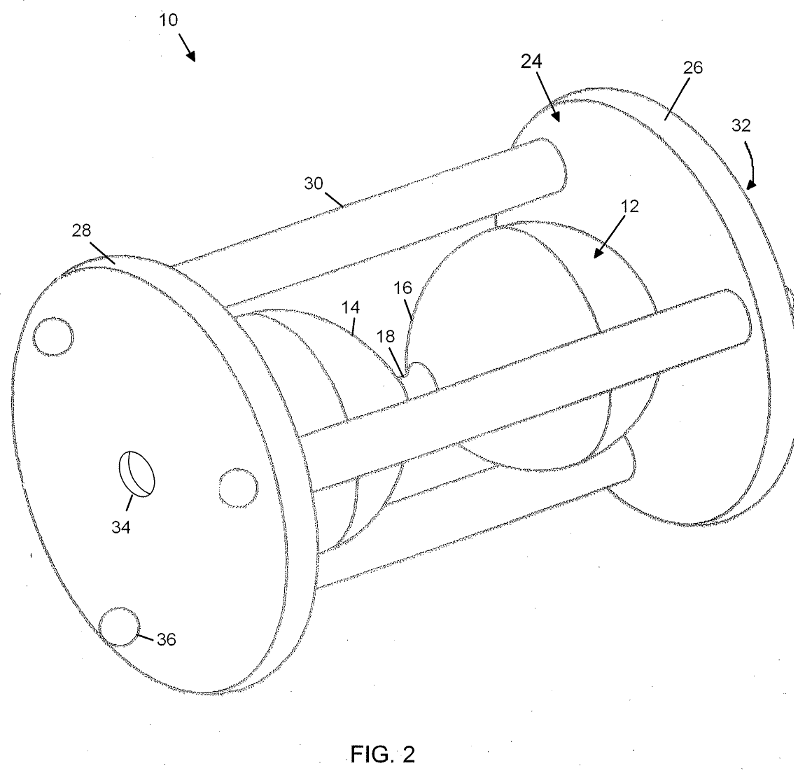

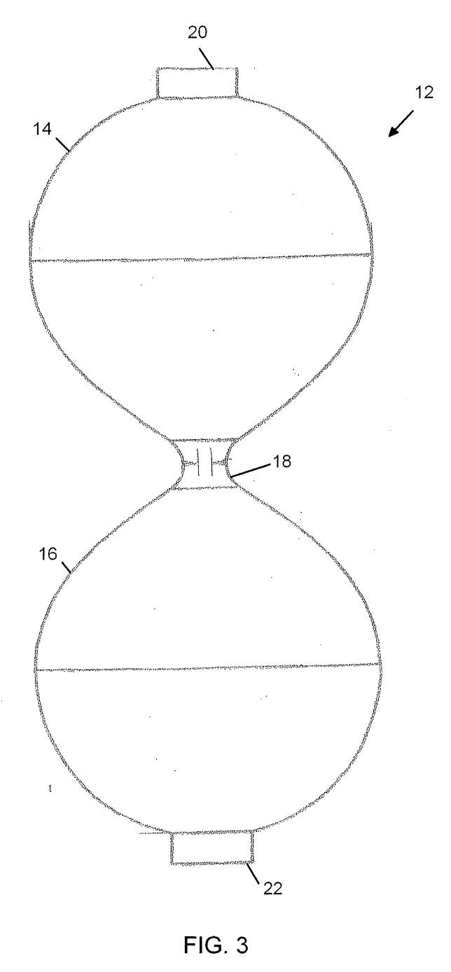

Hourglass 10 further comprises stoppers 36 and 38, shown in FIGS. 2 and 3 as decorative nautical steering wheels, which may be selectively positioned in apertures 32 and 34 formed through bases 26 and 28, respectively. As openings 20 and 22 in glass container 12 are aligned in fluid communication with apertures 34 and 36 in bases 26 and 28, insertion of stoppers 36 and 38 into apertures 32 and 34 will also effectively close openings 20 and 22. openings 20 and 22 may also include one or more gaskets positioned thereon, such as o-rings, to improve the seal when hourglass 10 is closed with stoppers 36 and 38. As seen in FIG. 3, stoppers 36 and 38 may be removed from bases 26 and 28, respectively, thereby permitting access to opening 14 and 14. Stoppers 36 and 38 may comprise any aesthetic or non-aesthetic designs, such as hearts, palm trees, shells, etc. as desired by end users.

As seen in FIG. 3, stopper 36 of hourglass 10 further comprises a threaded stud 40 extending outwardly therefrom and an O-ring 42 positioned around stud 40. It should be recognized by those of skill in the art that stud 40 engages aperture 32, which may be complementarily threaded, for the purposes of sealing aperture 32 and thus opening 14 closed. Hourglass 10 may thus be selectively opened and closed, thereby permitting access to the interior thereof for filling and emptying purposes. To open and close hourglass 10, a user simply turns either of stopper 36 or 38 until it is removed. With stoppers 36 and 38 removed from hourglass 10, openings 20 and 22 allow for the filling and emptying of the hourglass with materials like sand, soil, small shells, pebbles, and other materials the user wishes to store and display. Openings 20 and 22 are thus appropriately dimensioned to allow such filling or emptying, and to seal with apertures 34 and 34 when stoppers 36 and 38 are in place.

Hourglass 10 may be provided in any variety of styles. For example, pillars 30 may be manufactured from wood or stone, be smooth or shaped in the form of a twisted rope, and left plain or colored with paints, stains, or finishes.

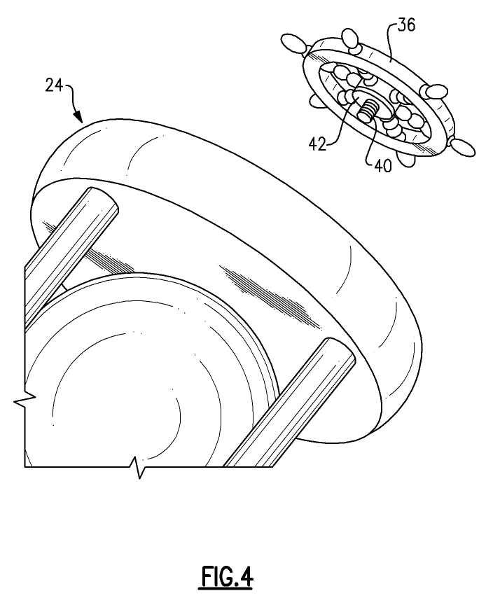

Hourglass 10 may be provided along with a kit 42 for use in carious ceremonies. For example, as seen in FIG. 4, kit 42 may comprise a screen 44 configured to filter out materials that are too large to pass through neck 40. It should be recognized by those of skill in the art that the apertures or gaps in screen 44 should be configured to exclude materials that are too large to pass through neck 18, such as by being slightly smaller in diameter than the diameter of neck 18. Kit 42 may further comprise a funnel 46 to assist with the filling of hourglass 10 and a pipe cleaner 48 to assist with clearing particular matter.

Hourglass 10 may be used in connection with an hourglass wedding unity sand ceremony, where a couple pours sand into hourglass 10, either separately or jointly, and the sand flows together in hourglass 10. Funnel 46 is particularly useful for an hourglass wedding unity sand ceremony as it allows the participants greater freedom. At the conclusion of the ceremony, the couple seals hourglass 10, thereby creating an heirloom. Kit 42 may further comprise a book 50 in which personal information may be written, and hourglass 10 may be provided with a plaque on which information may be printed or engraved.

Hourglass 10 may also be used to fill, store, and display human or animal crematory remains, sand or items of personal value, or whatever is desirable as a means to symbolize the deceased. Hourglass 10 is, in and of itself, symbolic of the passage of time and of eternity by virtue of the use of an hourglass. Hourglass 10 also provides funeral homes, funeral directors, and others within the funeral industry with a means to have access to the interior of an hourglass for the purposes of storing and displaying cremated remains. Additionally, many people spread the ashes of deceased loved ones or pets over bodies of water, but keep a small percentage of these ashes for remembrance. The ashes kept may be mixed with sands or soils from that location that was significant to them or to the deceased, and stored inside hourglass 10. When used in this manner, glass container 12 may be left clear, or it may be frosted or even colored. It is widely recognized that some people may want to be able to see the ashes and some may not. Glass container 12 may thus be configured accordingly. In addition, various components of hourglass 10 may be personalized or embellished with photos, engravings, religious verses, birthstones, gemstones, military insignia, and/or other items and symbols that serve as proper memorials and means of remembrance of the deceased. A supplemental funeral ceremony may also be developed and offered in many variations, and the invention may be modified to fill the needs or preferences of various religious beliefs, personal preferences, and a variety of funeral and memorial styles and traditions. Additionally, the dimensions of the parts of hourglass 10 may be adjusted to various sizes to accept various amounts of crematory remains and/or other materials depending upon the application. Other methods of sealing the glass component may also be developed further, and these may include the use of various gaskets or gasket material in the end of the threaded closures and elsewhere to further achieve an air tight seal, or simply as a further means of preventing moisture in any form from entering the glass.

Hourglass 10 may be used as a keepsake for many other occasions in addition to those described above. For example, hourglass 10 may be used sand collecting, honeymoons, birthdays, graduations, anniversaries, Valentine's Day/Sweetest Day, wedding showers, baby showers, for horse lovers that collect soil from a track or arena, owners of vacations homes, lodges, and camps, vow renewals, and wine enthusiasts.

While the preferred embodiments of hourglass 10 have been described and illustrated for convenience and clarity, it will be appreciated that many changes may be made thereon within the spirit of invention and continuous improvement. The descriptions and illustrations are for the purposes of example, and the scope of the invention is not to be limited to the exact details illustrated or described.

What is claimed is:

1. An hourglass, comprising:
a container defining two chambers, each of which has a first predetermined diameter and are separated by neck having a second, smaller diameter; and
at least one opening formed in said container that is in fluid communication with one of said chambers.

2. The hourglass of claim 1, further comprising:
a base having an aperture formed therethough;
a stopper for selectively opening and closing said aperture; and
wherein said container is positioned in said base such that said at least one opening is positioned proximately to and in fluid communication with said aperture of said base.

3. The hourglass of claim 2, wherein said base includes two opposing supports held in spaced relation by a plurality of pillars.

4. The hourglass of claim 3, wherein said stopper and said aperture are correspondingly threaded for selective engagement with each other.

5. The hourglass of claim 4, wherein said at least one opening includes a gasket positioned to sealingly engage said stopper when said stopper is threadably engaged with said base.

6. The hourglass of claim 5, wherein said pillars are connected to said base by threaded knobs.

7. The hourglass of claim 6, wherein the stopper comprises an ornamental support and a threaded post extending from said support.

8. An hourglass kit, comprising:
an hourglass including a container defining two chambers, each of which has a first predetermined diameter and are separated by neck having a second, smaller diameter; at least one opening formed in said container that is in fluid communication with one of said chambers;
a screen adapted to filter out particular having a second diameter; and
a funnel having a end dimensioned to pass through said aperture of said base and said opening of said container.

9. The hourglass of claim 8, further comprising:
a base comprising two opposing supports held in spaced relation by a plurality of pillars and including an aperture formed therethough; and
a stopper for selectively opening and closing said aperture; wherein said container is positioned in said base such that said opening of said container is positioned proximately to and in fluid communication with said aperture of said base.

10. The hourglass of claim 9, wherein said stopper and said aperture are correspondingly threaded for selective engagement with each other.

11. The hourglass of claim 10, wherein said stopper including a gasket positioned to sealingly engage said base when said stopper is threadably engaged therewith.

12. The hourglass of claim 11, wherein said pillars are connected to said base by threaded balls.

13. The hourglass of claim 12, wherein the stopper comprises an ornamental support and a threaded post extending from said support.

14. A method of preserving particulate matter, comprising the steps of:
providing an hourglass comprising a container defining two chambers, each of which has a first predetermined diameter and are separated by neck having a second, smaller diameter, wherein said hourglass includes at least one opening formed in said container that is in fluid communication with one of said chambers; and
filling said hourglass with said particulate matter.

15. The method of claim 14, wherein the step of filling said hourglass with said particular matter comprises the step of filling said hourglass with said particulate matter during a wedding ceremony.

16. The method of claim 15, wherein the particulate matter at least partially comprises sand.

17. The method of claim 15, wherein the particulate matter at least partially comprises crematory ashes.
